(19) United States
(12) Patent Application Publication
(10) Pub. No.: US 2005/0084642 A1
(43) Pub. Date: Apr. 21, 2005

(54) Plate-shaped or disc-shaped body

(76) Inventors: Leonhard Arnold, Pohlheim (DE); Martin Schwarzer, Schoffengrund (DE); Volker Banhardt, Bensheim (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/497,167

(22) PCT Filed: Dec. 11, 2002
(86) PCT No.: PCT/EP02/14095

(30) Foreign Application Priority Data
Dec. 12, 2001 (DE) 101 61 107.2

(51) Int. Cl. B32B 3/02

(52) U.S. Cl. 428/64.1; 264/154

(57) ABSTRACT

A plate-shaped body made of plastic material including a carbon-based filler material, the body having a recessed passageway. The recess is produced by punching, so that the passageway is accurately arranged in the body.

The invention relates to a plate or disk-like body of a plastic or synthetic resin or pitch-bound carbon or graphite material, preferably of a heat-curable or thermoplastic plastic with carbon or graphite material with a filler proportion of in particular 70% by weight up to 95% by weight, especially in the form of a plate or bipolar plate destined for a fuel cell or carbon commutator plate or contact plate for a grounding contact, whereby the disk or plate-like body has a passage recess.

Furthermore, the invention relates to a method for constructing a passage recess in a plate or disk-like body of a plastic or synthetic resin or pitch-bound material, preferably heat-curable or thermoplastic plastic with a carbon or graphite filler with a filler proportion from in particular 70% by weight to 95% by weight.

Chemical energy can be transformed directly into electric current with a high degree of efficiency in fuel cells. The basic principle is realized by a spatial separation of reaction partners such as hydrogen or methane on the one hand and oxygen or air of the other hand by an ion-conductive electrolyte such as polymer electrolyte membrane, which is in contact on both sides with porous electrodes-the anode and the cathode. In this way, the chemical reaction between hydrogen and oxygen can run not explosion-like, as an oxyhydrogen gas reaction, but can be conducted controlled such that an electron exchange between the reaction partners takes place through an external electric circuit and consequently supplies electrical energy.

Corresponding fuel cells have bipolar plates arranged in stacks with membrane electrode arrangements (MEA) arranged between these. In order to assure sufficient tightness between the plates, the latter can be clamped. For this, bore holes extending flush in relation to one another are introduced into the plates, which are penetrated by clamping elements. The holes can be created by drilling or milling. This is expensive and therefore burdened with the disadvantage of not being suited for mass production.

Plate-like carbon commutator plates or contact plates for grounding contacts must also be provided with holed so that the former can be fastened. The holes are likewise created by milling or drilling.

Creating the holes during molding of the plate is also known.

A method for manufacturing of molded bodies, for example in the form of plates destined for electrical or electrochemical purposes is known from DE 195 42 721 A1, which consist of plastic filler mixtures with a high filler content. Moreover the plates can be provided with a contour on one or on both of its flat sides. This can take place using, for example, embossing rollers or machining processing on program-controlled machining equipment.

A bipolar plate according to DE 100 19 094 A1 consists of an external region of electrically non-conductive plastic and an internal metallic or carbon-containing region. The internal part has millings for forming channels. The external parts are provided with bore holes for stack assembly.

The present invention is based upon the problem of furnishing a plate or disk-like body of the type mentioned at the beginning with at least one passage recess which is precise regarding shape and positioning.

The problem is basically solved in accordance with the invention in that the passage recess in the plate or disk-like body is constructed by stamping. In particular, the passage recess is produced by means of perforating or notching.

Deviating from the previously known state of the art, no machining operation takes place to create holes or notches, but rather a cutting out with a stamping tool, such as in particular a press.

It is provided in further development of the invention that the perforation formed by stamping runs in a region of the disk-like body that has a thickness D with D≦5 mm, especially D≦2 mm.

Deviating from the previously known state of the art, a plate or disk-like body of a plastic, synthetic resin or pitch-bound carbon or graphite material with a perforation is made available that is not constructed by milling or boring or pressing, but is rather manufactured by stamping. In this way, a perforation is made available that does not require reprocessing. Also exact positioning is guaranteed.

A method for constructing a passage opening in a plate or disk-like body of a plastic or synthetic resin or pitch-bound carbon or graphite material, especially of heat-curable or thermoplastic plastic with plastic filler with a filler proportion of in particular 70% by weight to 95% by weight, is distinguished in that the passage recess is formed by stamping. Moreover, the stamping in particular takes place by a precision blanking tool. In particular, the plate or disk-like body should be stamped out in a region in which it has a thickness D with ≦5 mm, especially D≦2 mm.

The invention is also distinguished by the use of a plate or disk-like body with a passage perforation created by stamping as a bipolar plate designed for a fuel cell, as a carbon commutator plate or contact plate for a grounding contact.

The invention will be explained in greater detail below on the basis of preferred embodiments.

### EXAMPLE 1

For manufacturing a bipolar plate designed for a fuel cell, 900 g of graphite with a grain size fraction up to 200 μm of spherical shape, 100 g of phenolic resin were mixed in a mixer at a temperature of 80° C. over a period of 10 min. The mixture was subsequently transferred into the pressing die of a heat press in order then to manufacture the bipolar plate by means of plastic deformation and curing of the mixture in heat presses. The upper and/or lower die of the press moreover have a profiling structure so that channels running meander-like are formed in the plate over which reactands flow in the assembled fuel cell.

The finished plates are fed to a precision blanking tool to stamp them in order to make passage bore holes or notches in corner regions.

### EXAMPLE 2

To manufacture a flat commutator, 70% by weight of coke, 30% by weight of graphite and 10% by weight of soot were mixed, ground and pressed together with 30% by weight of pitch in relation to the solids coke, graphite and soot. Subsequently annealing took place at a temperature of ca. 1000° C. and a graphitizing took place at a temperature of ca. 2800° C. Then platelets of a thickness of 3 mm and an outside diameter of 35 mm were manufactured. Passage apertures with an inside diameter of 10 mm were stamped in the latter.

### EXAMPLE 3

In order to provide resistor rings with holes, an initial mixture corresponding to example 2 was mixed, ground and pressed together and annealed at a temperature of ca. 1000° C. Nonetheless a graphitizing did not take place. We obtained disk-like thin layers with a thickness of 1.2 mm and an outside diameter of 100 mm, into which holes with an inside diameter of 85 mm were stamped.

Further details, advantages and features of the invention also become apparent from the embodiments explained below, wherein:

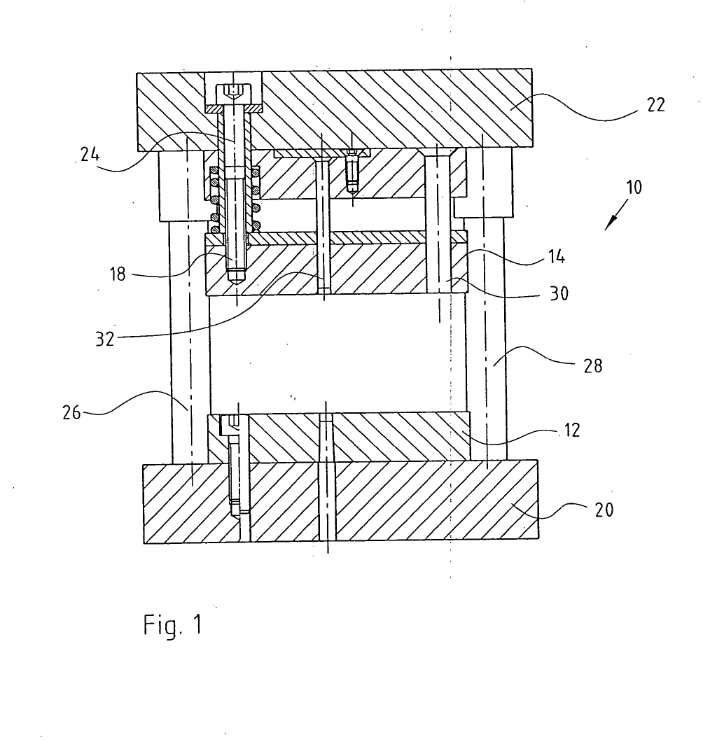

FIG. 1 Illustrates a basic representation of a tool for constructing passage recesses and

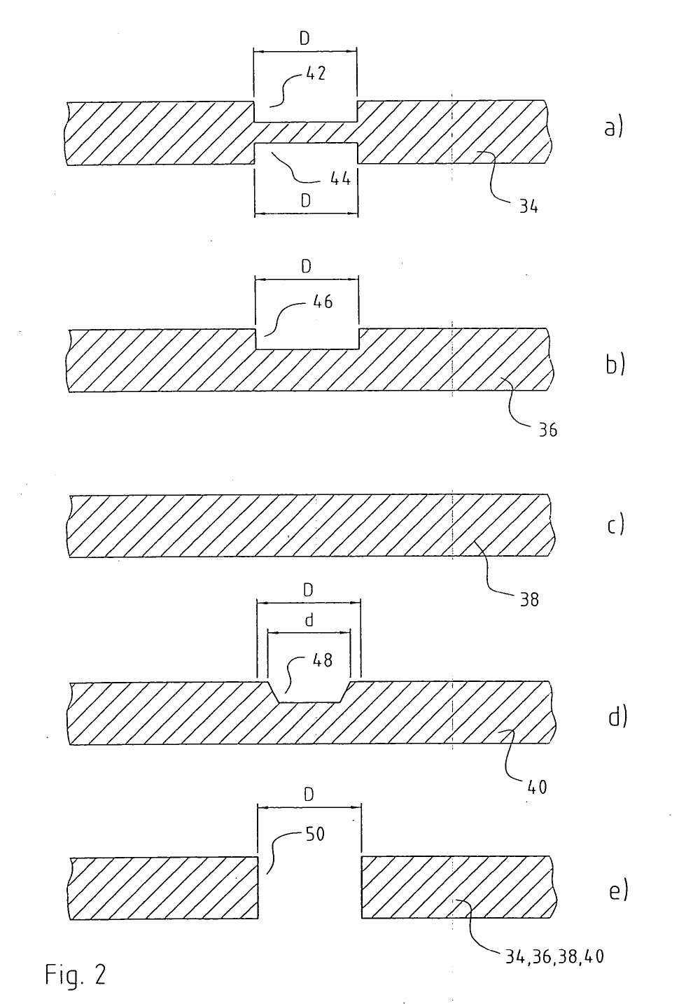

FIG. 2 Illustrates a basic representation of various initial bodies as well as corresponding body provided with a passage recess.

In order to create a passage bore hole by stamping in a plate or disk-like body which especially consists of a heat-curable or thermoplastic plastic with carbon or synthetic graphite with a filler component of in particular 70% by weight to 95% by weight, a device 10 is used which comprises a die plate 12, a hold down clamp 14 and punching elements 30, 32 as basic components.

The die plate 12 is mounted upon a support 20 in relation to which the hold down clamp 14 can be adjusted, which in turn extends from a mounting 22, which can be axially adjusted through spring-prestressed guide elements 24 in relation to the hold down clamp 14. The mounting 22 itself can be adjusted along columns 26, 28.

The hold down clamp 14 is penetrated by punches 30, 32 extending from the mounting 22 by means of which passage apertures are to be constructed in a body, which can be positioned on the die plate 12. Moreover the hold down clamp 14 presses the body with the necessary contact pressure onto the die plate 12 before the passage recess is stamped out using the punch 30 or 32. Typical contact pressures range between 2 MPa and 20 MPa or more.

Holes with diameters D of more than 1 mm in connection with a plate thickness preferably between 0.5 and 10 mm can be stamped out with high precision. Moreover, stamps can have cross sections to stamp out round holes, long holes, squares or rectangles, ellipses or other shapes.

Plate-like bodies 34, 36, 38, 40 are represented in a cut out section in FIG. 2a to d, which either can have a uniform thickness (FIG. 2c) prior to the stamping process or can have prestressed depressions 42, 44 in the region of the stamping to be conducted or prestamped depressions 46 the shape of which corresponds to the stamp out, so that in the event of a circle, the diameter D of the depressions 47, 44 corresponds to the stamped recess of the finished plate 34, 36, 38, 40.

A prepressed depression 48 with a small diameter d can also be preformed in a plate 40 in order to conduct the stamping process subsequently in order to stamp a passage perforation with a diameter D.

1. Plate or disk-like body (3, 36, 38, 40) of a plastic or synthetic resin or pitch-bound carbon or graphite material, preferably heat-curable or thermoplastic plastic with carbon or graphite filler with a filler proportion of especially 70% by weight up to 95% by weight, preferably in the form of a plate such as a bipolar plate designed for a fuel cell or carbon commutator plate or contact plate for a grounding contact, whereby the disk or plate-like body has a passage recess (5), wherein the passage recess (50) of the body (34, 36, 38, 40) is constructed by stamping.

2. Body according to claim 1, wherein the passage opening (50) is a perforation or a notching.

3. Body according to claim 1, wherein the plate or disk-like body (34, 36, 38, 40) has a thickness D with 0.5 mm≦D≦10 mm in the region of the passage opening, especially D≦2 mm.

4. Method for constructing a passage opening (50) in a plate or disk-like body (34, 36, 38, 40) of a plastic or synthetic resin or pitch-bound carbon or graphite material, especially curable or thermoplastic plastic with carbon filler with a filler proportion of in particular 70% by weight up to 95% by weight, wherein the passage opening (50) is created in the body (34, 36, 38, 40) by stamping.

5. Method according to claim 4, wherein the passage opening (50) is formed by a precision blanking tool.

6. Method according to claim 4, wherein the body (34, 36, 38, 40) is fixed between a die plate (12) and a hold down claim (14) with contact pressure p with 2 MPa≦p≦20 MPa, and then the passage bore hole (50) is stamped.

7. Method according to claim 4, wherein the perforation (50) is stamped in the plate or disk-like body (34, 36, 38, 40) in the region of a thickness D with 0.5 mm≦D≦10 mm, especially D≦2 mm.

8. A bipolar plate for a fuel cell, a carbon commutator plate, or a contact plate for a grounding contact comprising a plate or disk-like body (34, 36, 38, 40) of a plastic or synthetic resin or pitch-bound carbon or graphite material with a passage aperture formed by stamping.
